(19) United States
(12) Patent Application Publication
(10) Pub. No.: US 2025/0003380 A1
(43) Pub. Date: Jan. 2, 2025

(54) Hydroelectric Turbine Device and Method of Use

(71) Applicant: Boris Bankovsky, Walthem, MA (US)

(72) Inventor: Boris Bankovsky, Walthem, MA (US)

(21) Appl. No.: 18/540,355

(22) Filed: Dec. 14, 2023

Related U.S. Application Data
(60) Provisional application No. 63/523,719, filed on Jun. 28, 2023.

(51) Int. Cl. F03B 3/18

(52) U.S. Cl. CPC F03B 3/18

(57) ABSTRACT

A hydroelectric turbine device is disclosed. The device includes a plurality of high-flow water inlets symmetrically positioned on a stator. The inlets form a 3D cylindrical water vortex column inside the turbine, optimizing water flow dynamics around a centrally positioned rotor. The rotor is equipped with cylindrical blades, the blades adapted to 360-degree rotation, for interaction with the water vortex column to increase efficiency and power output. The turbine includes a generator for producing electric power. In some embodiments, an integrated charge storage system is provided for storing generated electricity. The turbine device does not have reflection and resistance zones within the rotor, thereby enhancing operational efficiency.

### CROSS-REFERENCE TO RELATED APPLICATION

The present application claims priority to, and the benefit of, U.S. Provisional Application No. 63/523,719, which was filed on Jun. 28, 2023 and is incorporated herein by reference in its entirety.

### FIELD OF THE INVENTION

The present invention generally relates to the field of hydroelectric turbines. More specifically, the present invention relates to a novel water vortex-based hydroelectric turbine device. The device includes a hydroelectric turbine with a rotor that has a plurality of blades that contact a water vortex column. The device has no zone of reflection and resistance inside the rotor during use. The device also has no power limit as the device creates a 3D cylinder water vortex column inside the turbine housing. Accordingly, the present disclosure makes specific reference thereto. Nonetheless, it is to be appreciated that aspects of the present invention are also equally applicable to other like applications, devices, and methods of manufacture.

### BACKGROUND

By way of background, hydroelectric turbines convert the kinetic energy of moving water into mechanical energy that can then be used to generate electricity. Hydroelectric turbines are primarily used to generate electricity. The mechanical energy produced by the turbine is converted into electrical energy by a generator. Hydroelectric power is a clean and renewable source of energy, and it can be used to meet both baseload and peak power demand. Additionally, hydroelectric turbines are also used for pumped water storage, flood control, and more.

Standard hydroelectric turbines have a zone of reflection and resistance. During movement of the rotor of the turbine, water flow is deflected back towards the upstream direction because the turbine blades are not perfectly streamlined, and there is some turbulence in the water flow. The reflected water can reduce the effective velocity of the water passing over the blades and creates a zone of reflection which reduces the power output and efficiency of the hydroelectric turbine. The zone of resistance is created when the water flow is impeded by the blades. The zone of resistance can be created due to thickness of the blades, the roughness of the blade surfaces, and the proximity of the blades to each other.

The presence of the zone of reflection and resistance in hydroelectric turbines limits power generation capacity of the turbines. The reflected water and the resistance to the water flow both reduce the effective velocity of the water passing over the blades, which in turn reduces the turbine's power output. There is a desire of an improved hydroelectric turbine that has no zone of reflection or resistance.

Therefore, there exists a long felt need in the art for an improved hydroelectric turbine. Additionally, there is a long felt need in the art for a hydroelectric turbine that has no zone of resistance or reflection. Moreover, there is a long felt need in the art for an improved hydroelectric turbine device that has no power generation limit Further, there is a long felt need in the art for a hydroelectric turbine device that provides continuous electric power with high efficiency. Furthermore, there is a long felt need in the art for a hydroelectric turbine that forms a water vortex column for the rotor. Also, there is a long felt need in the art for an improved hydroelectric turbine in which the rotor blades constantly contact a water stream. Finally, there is a long felt need in the art for a hydroelectric turbine device which focuses on maximizing efficiency and power output and eliminates zones of resistance and reflection.

The subject matter disclosed and claimed herein, in one embodiment thereof, comprises a hydroelectric turbine device. The hydroelectric turbine device does not have reflection and resistance zone within the rotor and has no power generation limit during operation. The turbine device can be used with any natural and artificial body of water and includes a plurality of high flow water inlets, each water inlet is configured to receive water from a body of water in which the turbine device is installed. A rotor is positioned centrally within a 3D cylindrical water vortex column formed by the water flow. The rotor includes a plurality of cylindrical or curvilinear blades that extend transversely from the rotor and are adapted to rotate 360-degrees, wherein the blades are continually exposed to and interact with the water vortex column, maximizing water flow dynamics around the rotor to enhance the efficiency and power output of the device. A generator is coupled with the turbine to produce electricity.

In this manner, the hydroelectric turbine device of the present invention accomplishes all of the forgoing objectives and provides user with a hydroelectric turbine that does not have zones of reflection and resistance within the rotor during operation. The turbine uses a water vortex column which minimizes internal flow disturbances and energy losses, leading to more efficient operation. The turbine has no power limit and can operate efficiently under varying water flow conditions and can potentially generate a significant amount of energy.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hydroelectric turbine device. The hydroelectric turbine device does not have reflection and resistance zone within the rotor during operation. The turbine device further comprising a plurality of high flow water inlets, symmetrically positioned on a stator. Each water inlet is configured to receive water from a body of water in which the turbine device is installed. A rotor is positioned centrally within a water vortex column formed by the water flow. The rotor includes a plurality of cylindrical or curvilinear blades that extend transversely from the rotor and are adapted to rotate 360-degrees, wherein the blades are continually exposed to and interact with the water vortex column, maximizing water flow dynamics around the rotor to enhance the efficiency and power output of the device.

In yet another embodiment, a hydroelectric turbine device with an optimized rotor-stator design for maximizing energy output is disclosed. The turbine device includes a stator and a rotor. The stator includes a plurality of water inlets, a plurality of electric generator couplings, and an inflow control module for independent monitoring and control of water flow through each inlet. A 3D cylindrical water vortex column is formed inside the turbine device, wherein blades of the rotor are continually exposed to and interact with the water vortex column. A pressure gradient is created between the rotor and stator wherein the pressure near the blades is approximately 50% of the pressure near the stator, thereby driving water movement and vortex formation.

In another embodiment, the pressure gradient eliminates zones of resistance and reflection to provide even distribution of force on the turbine blades and to reduce wear and tear.

In yet another embodiment, the turbine device includes a platform for secure placement in various types of water bodies, including both natural and artificial environments.

In another aspect, the turbine device includes a tubular member connecting the turbine and the generator.

In yet another aspect, the turbine device includes a charge storage system for storing the electric power generated using the turbine device.

In yet another embodiment, a method for operating a vortex-based hydroelectric turbine device adapted for converting the kinetic energy of water into electrical power with enhanced efficiency and no power limit is described. The method includes the steps of positioning the turbine in a body of water, allowing water to flow into the turbine through a plurality of inlets, each inlet facilitates the formation of a 3D cylindrical water vortex column inside the turbine, capturing kinetic energy of the vortex by a rotor, and converting the mechanical motion of the rotor, driven by the vortex, into electrical power using a generator coupled to the turbine.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the hydroelectric turbine device of the present invention in accordance with the disclosed structure;

FIG. 2 illustrates a cross-sectional view of the hydroelectric turbine device of the present invention in accordance with the disclosed structure; and

FIG. 3 illustrates a flow chart depicting use of the vortex-based hydroelectric turbine device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved hydroelectric turbine. Additionally, there is a long felt need in the art for a hydroelectric turbine that has no zone of resistance or reflection. Moreover, there is a long felt need in the art for an improved hydroelectric turbine device that has no power generation limit Further, there is a long felt need in the art for a hydroelectric turbine device that provides continuous electric power with high efficiency. Furthermore, there is a long felt need in the art for a hydroelectric turbine that forms a water vortex column for the rotor. Also, there is a long felt need in the art for an improved hydroelectric turbine in which the rotor blades constantly contact a water stream. Finally, there is a long felt need in the art for a hydroelectric turbine device which focuses on maximizing efficiency and power output and eliminates zones of resistance and reflection.

The present invention, in one exemplary embodiment, is a method for operating a vortex-based hydroelectric turbine device adapted for converting the kinetic energy of water into electrical power with enhanced efficiency and no power limit The method includes the steps of positioning the turbine in a body of water, allowing water to flow into the turbine through a plurality of inlets, each inlet facilitates the formation of a 3D cylindrical water vortex column inside the turbine, capturing kinetic energy of the vortex by a rotor, and converting the mechanical motion of the rotor, driven by the vortex, into electrical power using a generator coupled to the turbine.

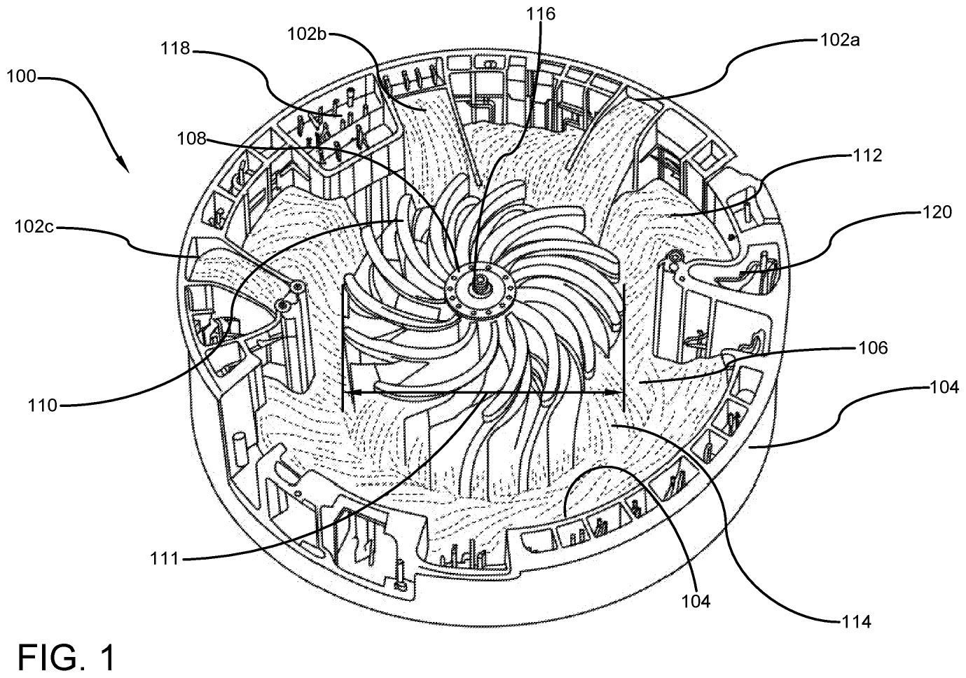

Referring initially to the drawings, FIG. 1 illustrates a perspective view of the hydroelectric turbine device of the present invention in accordance with the disclosed structure. The hydroelectric turbine device 100 is designed as an improved hydroelectric turbine device to convert the kinetic energy and potential energy of water into mechanical energy. The turbine device 100 does not have zones of reflection and resistance within the rotor during operation. More specifically, the turbine device 100 includes a plurality of high flow water inlets 102a-n (hereinafter, referred to as 102). Each inlet 102 is configured to receive water from a body of water in which the device 100 is installed. The inlets 102 are positioned on the stator 104 and the stator 104 can be circular or of any other geometrical shape. The inlets 102 are symmetrically placed along the stator 104 for providing a constant water flow for the hydroelectric turbine device 100.

The inlets 102 are adapted to form a 3D-cylindrical water vortex column 106 inside the turbine device 100 and a rotor 108 is positioned inside the water vortex column 106. The rotor 108 includes a plurality of cylindrical or curvilinear blades 110 and is adapted to rotate 360-degrees. The blades 110 of the rotor 108 are constantly exposed and touch the water vortex column 106, thereby maximizing the water flow dynamics around the rotor 108 to enhance the efficiency and power output of the turbine device 100. In one exemplary embodiment, the cylindrical or curvilinear blades 110 form a rotation diameter 111 and the stator 104 has an internal diameter 105, wherein diameter 111 is from about 50% to about 75% of the internal stator diameter 105.

When the water 112 flows through the inlets 102, a rotational movement 114 is created around the central axis 116 of the turbine 100 for forming the vortex 106. The rotor 108 is positioned along the center of the turbine 100 and the blades 110 extends transversely from the rotor 108. The blades 110 enhance the rotational movement of the water to maintain the rotational flow thereby strengthening the vortex 106.

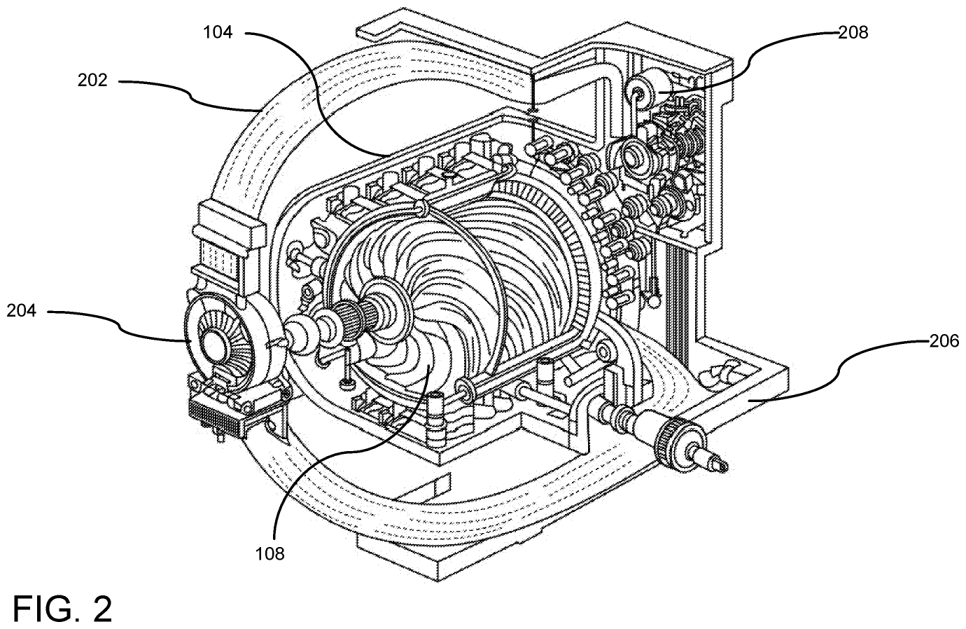

The stator 104 includes a plurality of electric generator couplings 118 for providing electrical coupling to generator and other external grids as illustrated in FIG. 2. The inlet water flow from each inlet can be independently monitored and controlled using an inflow control module 120. The flow speed and direction can be controlled depending on the electricity to be generated using the hydroelectric turbine device 100.

The water vortex column 106 creates a lower pressure area in the center of the turbine 100, which can pull more water through the turbine 100. Accordingly, the zones of resistance and reflection are removed which increases the amount of energy produced by the turbine device 100. The swirling motion of the vortex 106 also helps evenly distribute the force of the water on the turbine blades 110, which can reduce wear and tear.

In one exemplary embodiment, the pressure near the blades 110 is from 40% to 60% of the pressure near the stator 104 and the pressure gradient drives the movement of the water and the formation of the vortex 106. The pressure difference between the rotor 108 and the stator 106 also reduces turbulence and flow separation to eliminate zone of resistance and reflection.

FIG. 2 illustrates a cross-sectional view of the hydroelectric turbine device of the present invention in accordance with the disclosed structure. The turbine device 100 includes a tubular member 202 to route pressurized water around the electric generator 204. For secure placement of the turbine device 100, the device 100 includes a platform 206 and can be placed in any natural or artificial body of water. In preferred embodiments of the present invention, the turbine device 100 includes a charge storage system 208 for storing the electric power generated using the turbine device 100. The charge storage system 208 can be coupled with any grid or external power consuming site for utilizing the electricity produced by the turbine device 100.

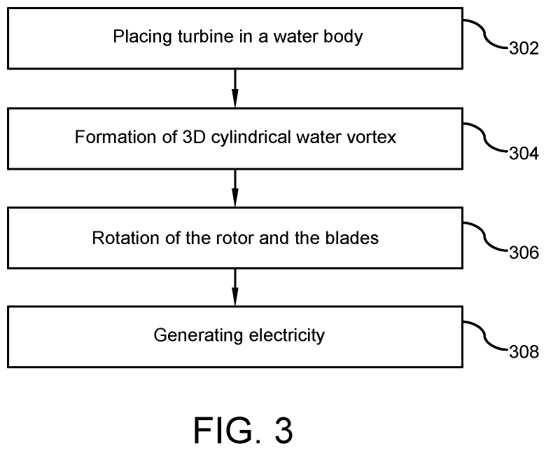

FIG. 3 illustrates a flow chart depicting use of the vortex-based hydroelectric turbine device of the present invention in accordance with the disclosed structure. Initially, the turbine is placed in a body of water with a consistent and strong flow of water (Step 302). The body of water can be a river, a dam, or any other suitable body of water. Then, the water flows into the turbine through the plurality of the inlets for formation of the 3D water vortex column (Step 304). The 3D cylindrical water vortex column is maintained inside the turbine housing for a consistent and efficient flow pattern around the rotor.

Thereafter, as the water flows and the vortex spins, the blades of the rotor capture the kinetic energy of the moving water and the water flows smoothly over the blades, enhancing efficiency (Step 306). Finally, the mechanical motion of the rotor is then transferred to the generator to generate the electric power (Step 308). The method used by the vortex-based hydroelectric turbine device 100 has no power limit and does not have reflection and resistance zones inside the rotor.

In some embodiments of the present invention, the position, and the angle of the blades 110 can be adjusted based on water flow and electricity demand. Further, the hydroelectric turbine 100 involves harnessing the kinetic energy of water through the uniquely designed rotor within the 3D cylindrical water vortex column 106.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “hydroelectric turbine device”, “turbine device”, “turbine”, “vortex-based hydroelectric turbine device”, and “zero reflection and resistance zone hydroelectric turbine device” are interchangeable and refer to the zero reflection and resistance zone hydroelectric turbine device 100 of the present invention.

Notwithstanding the forgoing, the zero reflection and resistance zone hydroelectric turbine device 100 of the present invention can be of any suitable size and configuration as is known in the art without affecting the overall concept of the invention, provided that it accomplishes the above stated objectives. One of ordinary skill in the art will appreciate that the zero reflection and resistance zone hydroelectric turbine device 100 as shown in the FIGS. are for illustrative purposes only, and that many other sizes and shapes of the zero reflection and resistance zone hydroelectric turbine device 100 are well within the scope of the present disclosure. Although the dimensions of the zero reflection and resistance zone hydroelectric turbine device 100 are important design parameters for user convenience, the zero reflection and resistance zone hydroelectric turbine device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hydroelectric turbine device for converting kinetic energy into mechanical energy, the hydroelectric turbine device comprising:
a hydroelectric turbine having a stator, a rotor, and a plurality of high flow water inlets, wherein each one of said plurality of water inlets receives water from a body of water in which said hydroelectric turbine is installed;
wherein said plurality of water inlets spaced along a portion of said stator for providing a constant water flow into said hydroelectric turbine;
wherein said rotor having a plurality of cylindrical blades and a central axis;
wherein said plurality of cylindrical blades rotate 360 degrees around said central axis;
wherein said portion is less than half a circumference of said stator;
wherein said plurality of water inlets upon receiving the water forms a 3D-cylindrical water vortex column inside said hydroelectric turbine with said rotor at a center of said water vortex column; and
further wherein said plurality of cylindrical blades are constantly exposed to said water vortex column and are turned by said water vortex column to convert kinetic energy of the water into mechanical energy.

2. The hydroelectric turbine device of claim 1, wherein said plurality of water inlets include three water inlets.

3. The hydroelectric turbine device of claim 2, wherein said rotor is centered in said hydroelectric turbine and said cylindrical blades extend transversely from said rotor.

4. The hydroelectric turbine device of claim 3, wherein said plurality of water inlets symmetrically spaced along said portion of said stator.

5. The hydroelectric turbine device of claim 4, wherein said stator is circular.

6. The hydroelectric turbine device of claim 5, wherein said stator having a plurality of electric generator couplings for providing electrical coupling to a generator.

7. The hydroelectric turbine device of claim 6, wherein each one of said plurality of water inlets having an inflow control module for independently monitoring and controlling the inflow of water through said plurality of water inlets.

8. The hydroelectric turbine device of claim 7, wherein said water vortex column having a pressure gradient including a first water pressure near the center of said hydroelectric turbine and a second water pressure near said stator, and further wherein said first pressure is from 40% to 60% of said second water pressure.

9. A hydroelectric turbine device for converting kinetic energy into mechanical energy, the hydroelectric turbine device comprising:
a hydroelectric turbine having a stator, a rotor, and a plurality of high flow water inlets, wherein each one of said plurality of water inlets receives water from a body of water in which said hydroelectric turbine is installed;
wherein said plurality of water inlets spaced along a portion of said stator for providing a constant water flow into said hydroelectric turbine;
wherein said rotor having a plurality of cylindrical blades and a central axis;
wherein said plurality of cylindrical blades rotate 360 degrees around said central axis;
wherein said portion is less than half a circumference of said stator;
wherein said plurality of water inlets upon receiving the water forms a 3D-cylindrical water vortex column inside said hydroelectric turbine with said rotor at a center of said water vortex column;
wherein said plurality of cylindrical blades are constantly exposed to said water vortex column and are turned by said water vortex column to convert kinetic energy of the water into mechanical energy;
wherein said plurality of water inlets symmetrically spaced along said portion of said stator;
wherein said water vortex column having a pressure gradient including a first water pressure proximal to the center of said hydroelectric turbine and a second water pressure proximal to said stator;
wherein said first pressure is from 40% to 60% of said second water pressure;
wherein said cylindrical blades having a rotation first diameter and said stator having an internal second diameter; and
further wherein said first diameter is from 50% to 75% of said second diameter.

10. The hydroelectric turbine device of claim 9, wherein said plurality of water inlets include three water inlets.

11. The hydroelectric turbine device of claim 10, wherein said rotor is centered in said hydroelectric turbine and said cylindrical blades extend transversely from said rotor.

12. The hydroelectric turbine device of claim 11, wherein said stator having a plurality of electric generator couplings for providing electrical coupling to a generator.

13. The hydroelectric turbine device of claim 12, wherein each one of said plurality of water inlets having an inflow control module for independently monitoring and controlling the inflow of water through said plurality of water inlets.

14. A method of converting kinetic energy into mechanical energy using a hydroelectric turbine device, the method comprising the steps of:
providing a hydroelectric turbine having a stator, a rotor, and a plurality of high flow water inlets, wherein each one of said plurality of water inlets receives water from a body of water in which said hydroelectric turbine is installed, further wherein said rotor having a plurality of cylindrical blades and a central axis;
spacing said plurality of water inlets along a portion of said stator for providing a constant water flow into said hydroelectric turbine, wherein said portion is less than half a circumference of said stator, further wherein said plurality of water inlets symmetrically spaced along said portion of said stator;
rotating said plurality of cylindrical blades 360 degrees around said central axis, wherein said cylindrical blades having a rotation first diameter and said stator having an internal second diameter, further wherein said first diameter is from 50% to 75% of said second diameter;
receiving water into said plurality of water inlets;
forming a 3D-cylindrical water vortex column inside said hydroelectric turbine with said rotor at a center of said water vortex column;
exposing said plurality of cylindrical blades to said water vortex column;
turning said plurality of cylindrical blades; and
converting kinetic energy of the water into mechanical energy.

15. The method of using the hydroelectric turbine device of claim 14, wherein said plurality of water inlets include three water inlets.

16. The method of using the hydroelectric turbine device of claim 15, wherein said rotor is centered in said hydroelectric turbine and said cylindrical blades extend transversely from said rotor.

17. The method of using the hydroelectric turbine device of claim 16, wherein said stator having a plurality of electric generator couplings for providing electrical coupling to a generator.

18. The method of using the hydroelectric turbine device of claim 17, wherein each one of said plurality of water inlets having an inflow control module for independently monitoring and controlling the inflow of water through said plurality of water inlets.

19. The method of using the hydroelectric turbine device of claim 14, wherein said water vortex column having a pressure gradient including a first water pressure proximal to the center of said hydroelectric turbine and a second water pressure proximal to said stator, further wherein said first pressure is less than said second water pressure.

20. The method of using the hydroelectric turbine device of claim 19, wherein said first pressure is from 40% to 60% of said second water pressure.
